(19) United States
(12) Patent Application Publication
(10) Pub. No.: US 2026/0015441 A1
(43) Pub. Date: Jan. 15, 2026

(54) CATALYST COMPONENTS FOR THE POLYMERIZATION OF OLEFINS

(71) Applicant: Basell Poliolefine Italia S.r.l., Milano (IT)

(72) Inventors: Leonardo Brustolin, Ferrara (IT); Luigi Cavallo, Fisciano (IT); Antonio Cristofori, Ferrara (IT); Laura Falivene, Fisciano (IT); Alessandro Mignogna, Ferrara (IT); Giampiero Morini, Ferrara (IT); Fabrizio Piemontesi, Ferrara (IT); Lorenzo Veronese, Ferrara (IT); Gianni Vitale, Ferrara (IT); Gianni Collina, Ferrara (IT); Benedetta Gaddi, Ferrara (IT); Ofelia Fusco, Ferrara (IT); Piero Gessi, Ferrara (IT)

(73) Assignee: Basell Poliolefine Italia S.r.l., Milano (IT)

(21) Appl. No.: 18/881,870

(22) PCT Filed: Jul. 6, 2023
(86) PCT No.: PCT/EP2023/068696

§ 371 Date: Jan. 7, 2025

(30) Foreign Application Priority Data
Jul. 7, 2022 (EP) 22183631.5

(51) Int. Cl. C08F 110/06

(52) U.S. Cl. CPC C08F 110/06; C08F 2410/01

(57) ABSTRACT

A solid catalyst component for the polymerization of olefins made from or containing a magnesium halide, a titanium compound having at least a Ti-halogen bond, and at least an electron donor compound selected from 1,3-diethers.

### FIELD OF THE INVENTION

In general, the present disclosure relates to the field of chemistry. More specifically, the present disclosure relates to polymer chemistry. In particular, the present disclosure relates to Ziegler-Natta heterogeneous catalyst components for the polymerization of olefins.

### BACKGROUND OF THE INVENTION

In some instances, catalyst components are used for the stereospecific polymerization of olefins. Concerning the polymerization of propylene, Ziegler-Natta catalysts are used which are made from or containing a solid catalyst component, constituted by a magnesium dihalide on which are supported a titanium compound and an internal electron donor compound, used in combination with an Al-alkyl compound. In some instances, an external donor is used to obtain higher crystallinity and higher isotacticity of the polymer. In some instances, the external donor is an alkoxysilane. In some instances, esters of phthalic acid are used as internal donors in catalyst preparations. In some instances, the ester of phthalic acid is diisobutylphthalate. In some instances, phthalates are used as internal donors in combination with alkylalkoxysilanes as external donor.

In some instances, the catalyst systems do not use phthalates as an electron donor.

### SUMMARY OF THE INVENTION

In a general embodiment, the present disclosure provides a solid catalyst component for the polymerization of olefins made from or containing a magnesium halide, a titanium compound having at least a Ti-halogen bond, and at least an electron donor of formula (I)

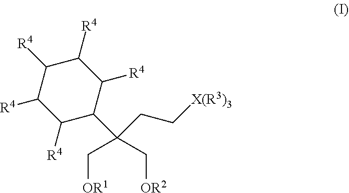

wherein R¹ and R² are, independently, C₁-C₈alkyl groups, X is Si or C, R³ and R⁴ groups, independently, are selected from the group consisting of hydrogen, C₁-C₂₀ hydrocarbon groups and halogens with the proviso that at least two R³ are not hydrogen.

### DETAILED DESCRIPTION OF THE INVENTION

In some embodiments, R¹ and R² are the same and selected from C₁-C₄ linear or branched alkyl groups. In some embodiments, R¹ and R² are methyl groups.

As used herein, the term “hydrocarbon groups” includes distinct groups such as alkyl, cycloalkyl, arylalkyl, alkenyl, aryl, and arylalkylaryl. In some embodiments, the hydrocarbon groups are fused together, thereby forming saturated or unsaturated cycles.

In some embodiment, R⁴ groups, independently, are selected from the group consisting of hydrogen, C₁-C₁₀ hydrocarbon groups and halogens. In some embodiment, R⁴ groups are selected from hydrogen, C₁-C₄ linear or branched alkyl groups and halogens. In some embodiments, one or two of R⁴ groups are C₁-C₄ linear or branched alkyl groups or halogen. In some embodiments, the alkyl groups are methyl, isopropyl or t-butyl. In some embodiments, the halogens are selected from the group consisting of Cl and F. In some embodiments, the R⁴ groups are hydrogen.

In some embodiments, R³ groups are selected from the group consisting of hydrogen, C₁-C₁₀ hydrocarbon groups, and halogens. In some embodiments, R³ is a hydrocarbon group selected from the group consisting of C₁-C₄ linear or branched alkyl groups, and groups linked together, thereby forming a C₆ saturated ring optionally substituted with C₁-C₄ linear alkyl groups. In some embodiments, the alkyl groups are selected from the group consisting of methyl, ethyl and isobutyl.

In some embodiments, R³ is a halogen selected from the group consisting of Cl and F. In some embodiments, R³ is F.

In some embodiments, X is carbon and R³ is a hydrogen, a C₁-C₂₀ hydrocarbon group or halogen. In some embodiments, the hydrocarbon group is selected from C₁-C₄ linear or branched alkyl groups. In some embodiments, the hydrocarbon group is methyl. In some embodiments, an R³ group is hydrogen and the remaining two R³ groups are methyl groups.

In some embodiments, X is carbon and R³ is hydrogen or a halogen group. In some embodiments, the halogen group is selected from the group consisting of Cl and F. In some embodiments, the halogen group is F. In some embodiments, at least two of R³ groups are F. In some embodiments, the R³ groups are F.

In some embodiments, X is Si and R³ is a hydrogen or hydrocarbon group. In some embodiments, the hydrocarbon group is selected from C₁-C₄ linear or branched alkyl groups. In some embodiments, the hydrocarbon group is methyl or ethyl. In some embodiments, the R³ groups are methyl.

In some embodiments, the compounds of formula (I) are selected from the group consisting of 2-cyclohexyl-2-isopentyl-1,3-dimethoxypropane, 2-cyclohexyl-2-(3,3-difluorobutyl)-1,3-dimethoxypropane, 2-cyclohexyl-2-(3,3-dibromobutyl)-1,3-dimethoxypropane, 2-cyclohexyl-2-(3,3-dichlorobutyl)-1,3-dimethoxypropane, 2-cyclohexyl-2-(3,3,3-trifluoropropyl)-1,3-dimethoxypropane, 2-cyclohexyl-2-(3,3,3-tribromopropyl)-1,3-dimethoxypropane, 2-cyclohexyl-2-(3,3,3-trichloropropyl)-1,3-dimethoxypropane, 2-cyclohexyl-2-(3,3-difluoropropyl)-1,3-dimethoxypropane, 2-cyclohexyl-2-(3,3-dibromopropyl)-1,3-dimethoxypropane, 2-cyclohexyl-2-(3,3-dichloropropyl)-1,3-dimethoxypropane, 2-cyclohexyl-2-(3,3-dichloro-3-fluoro-propyl)-1,3-dimethoxypropane, 2-cyclohexyl-2-(3,3-dichloro-3-bromo-propyl)-1,3-dimethoxypropane, 2-cyclohexyl-2-(3,3-difluoro-3-bromo-propyl)-1,3-dimethoxypropane, 2-cyclohexyl-2-(3,3-difluoro-3-chloro-propyl)-1,3-dimethoxypropane, 2-cyclohexyl-2-(3,3-difluoro-5-methylhexyl)-1,3-dimethoxypropane, 2-cyclohexyl-2-(3,3-dichloro-5-methylhexyl)-1,3-dimethoxypropane, 2-cyclohexyl-2-(3-chloro-3-isobutyl-5-methylhexyl)-1,3-dimethoxypropane, 2-cyclohexyl-2-(3-bromo-3-isobutyl-5-methylhexyl)-1,3-dimethoxypropane, 2-cyclohexyl-2-(3-fluoro-3-isobutyl-5-methylhexyl)-1,3-dimethoxypropane, 2-cyclohexyl-2-(3-fluoro-3-isopentyl-6-methylheptyl)-1,3-dimethoxypropane, 2-cyclohexyl-2-(3-chloro-3-isopentyl-6-methylheptyl)-1,3-dimethoxypropane, 2-cyclohexyl-2-(3-bromo-3-isopentyl-6-methylheptyl)-1,3-dimethoxypropane, 2-cyclohexyl-2-(3,3-diphenylbutyl)-1,3-dimethoxypropane, 2-cyclohexyl-2-(3,3-diphenylpropyl)-1,3-dimethoxypropane, 2-cyclohexyl-2-(3,3,3-triphenylpropyl)-1,3-dimethoxypropane, 2-cyclohexyl-2-(3,3,3-tris(4-chlorophenyl) propyl)-1,3-dimethoxypropane, 2-cyclohexyl-2-(3,3-dimethylbutyl)-1,3-dimethoxypropane, 2-cyclohexyl-2-(3-methylpentyl)-1,3-dimethoxypropane, 2-cyclohexyl-2-(3-ethylpentyl)-1,3-dimethoxypropane, 2-cyclohexyl-2-(3,3-diethylpentyl)-1,3-dimethoxypropane, 2-cyclohexyl-2-(3-isopropyl-4-methylpentyl)-1,3-dimethoxypropane, 2-cyclohexyl-2-(3,3-diisopropyl-4-methylpentyl)-1,3-dimethoxypropane, 2-cyclohexyl-2-(cyclohexylethyl)-1,3-dimethoxypropane, 2-cyclohexyl-2-(cyclopentylethyl)-1,3-dimethoxypropane, 2-cyclohexyl-2-(phenethyl)-1,3-dimethoxypropane, 2-cyclohexyl-2-(2-trimethylsilylethyl)-1,3-dimethoxypropane, 2-cyclohexyl-2-(2-triisopropylsilylethyl)-1,3-dimethoxypropane, 2-cyclohexyl-2-(2-triphenylsilylethyl)-1,3-dimethoxypropane, 2-cyclohexyl-2-(2-methyldiphenylsilylethyl)-1,3-dimethoxypropane, 2-cyclohexyl-2-(2-dimethylphenylsilylethyl)-1,3-dimethoxypropane, 2-cyclohexyl-2-(2-(tris(4-chlorophenyl) silyl)ethyl)-1,3-dimethoxypropane, 2-cyclohexyl-2-(2-(bis(4-chlorophenyl)(methyl) silyl)ethyl)-1,3-dimethoxypropane, 2-cyclohexyl-2-isopentyl-1,3-diallyloxypropane, 2-cyclohexyl-2-(3,3-difluorobutyl)-1,3-diethoxypropane, 2-cyclohexyl-2-(3,3-dibromobutyl)-1,3-diallyloxypropane, 2-cyclohexyl-2-(3,3-dichlorobutyl)-1,3-diethoxypropane, 2-cyclohexyl-2-(3,3,3-trifluoropropyl)-1,3-diethoxypropane, 2-cyclohexyl-2-(3,3,3-tribromopropyl)-1,3-diethoxypropane, 2-cyclohexyl-2-(3,3,3-trichloropropyl)-1,3-dipropoxypropane, 2-cyclohexyl-2-(3,3-difluoropropyl)-1,3-diallyloxypropane, 2-cyclohexyl-2-(3,3-dibromopropyl)-1,3-diethoxypropane, 2-cyclohexyl-2-(3,3-dichloropropyl)-1,3-dipropoxypropane, 2-cyclohexyl-2-(3,3-dichloro-3-fluoro-propyl)-1,3-diethoxypropane, 2-cyclohexyl-2-(3,3-dichloro-3-bromo-propyl)-1,3-dipropoxypropane, 2-cyclohexyl-2-(3,3-difluoro-3-bromo-propyl)-1,3-dibutoxypropane, 2-cyclohexyl-2-(3,3-difluoro-3-chloro-propyl)-1,3-dipropoxypropane, 2-cyclohexyl-2-(3,3-difluoro-5-methylhexyl)-1,3-diethoxypropane, 2-cyclohexyl-2-(3,3-dichloro-5-methylhexyl)-1,3-dipropoxypropane, 2-cyclohexyl-2-(3-chloro-3-isobutyl-5-methylhexyl)-1,3-diisopentoxypropane, 2-cyclohexyl-2-(3-bromo-3-isobutyl-5-methylhexyl)-1,3-diethoxypropane, 2-cyclohexyl-2-(3-fluoro-3-isobutyl-5-methylhexyl)-1,3-dipropoxypropane, 2-cyclohexyl-2-(3-fluoro-3-isopentyl-6-methylheptyl)-1,3-diethoxypropane, 2-cyclohexyl-2-(3-chloro-3-isopentyl-6-methylheptyl)-1,3-dibutoxypropane, 2-cyclohexyl-2-(3-bromo-3-isopentyl-6-methylheptyl)-1,3-dipropoxypropane, 2-cyclohexyl-2-(3,3-diphenylbutyl)-1,3-diallyloxypropane, 2-cyclohexyl-2-(3,3-diphenylpropyl)-1,3-diallyloxypropane, 2-cyclohexyl-2-(3,3,3-triphenylpropyl)-1,3-diethoxypropane, 2-cyclohexyl-2-(3,3,3-tris(4-chlorophenyl) propyl)-1,3-diallyloxypropane, 2-cyclohexyl-2-(3,3-dimethylbutyl)-1,3-diethoxypropane, 2-cyclohexyl-2-(3-methylpentyl)-1,3-diallyloxypropane, 2-cyclohexyl-2-(3-ethylpentyl)-1,3-diisopentoxypropane, 2-cyclohexyl-2-(3,3-diethylpentyl)-1,3-diethoxypropane, 2-cyclohexyl-2-(3-isopropyl-4-methylpentyl)-1,3-diethoxypropane, 2-cyclohexyl-2-(3,3-diisopropyl-4-methylpentyl)-1,3-diethoxypropane, 2-cyclohexyl-2-(cyclohexylethyl)-1,3-diethoxypropane, 2-cyclohexyl-2-(cyclopentylethyl)-1,3-diallyloxypropane, 2-cyclohexyl-2-(phenethyl)-1,3-diisopentoxypropane, 2-cyclohexyl-2-(2-trimethylsilylethyl)-1,3-dibutoxypropane, 2-cyclohexyl-2-(2-triisopropylsilylethyl)-1,3-diisopentoxypropane, 2-cyclohexyl-2-(2-triphenylsilylethyl)-1,3-diethoxypropane, 2-cyclohexyl-2-(2-methyldiphenylsilylethyl)-1,3-diethoxypropane, 2-cyclohexyl-2-(2-dimethylphenylsilylethyl)-1,3-diethoxypropane, 2-cyclohexyl-2-(2-(tris(4-chlorophenyl) silyl)ethyl)-1,3-dibutoxypropane, 2-cyclohexyl-2-(2-(bis(4-chlorophenyl)(methyl) silyl)ethyl)-1,3-dibutoxypropane, 2-cyclohexyl-2-isopentyl-1-ethoxy-3-methoxy-propane, 2-cyclohexyl-2-(3,3-difluorobutyl)-1-ethoxy-3-methoxy-propane, 2-cyclohexyl-2-(3,3-dibromobutyl)-1-ethoxy-3-methoxy-propane, 2-cyclohexyl-2-(3,3-dichlorobutyl)-1-ethoxy-3-methoxy-propane, 2-cyclohexyl-2-(3,3,3-trifluoropropyl)-1-ethoxy-3-methoxy-propane, 2-cyclohexyl-2-(3,3,3-tribromopropyl)-1-ethoxy-3-methoxy-propane, 2-cyclohexyl-2-(3,3,3-trichloropropyl)-1-methoxy-3-allyloxy-propane, 2-cyclohexyl-2-(3,3-difluoropropyl)-1-ethoxy-3-methoxy-propane, 2-cyclohexyl-2-(3,3-dibromopropyl)-1-ethoxy-3-methoxy-propane, 2-cyclohexyl-2-(3,3-dichloropropyl)-1-ethoxy-3-methoxy-propane, 2-cyclohexyl-2-(3,3-dichloro-3-fluoro-propyl)-1-isobutoxy-3-methoxy-propane, 2-cyclohexyl-2-(3,3-dichloro-3-bromo-propyl)-1-ethoxy-3-methoxy-propane, 2-cyclohexyl-2-(3,3-difluoro-3-bromo-propyl)-1-ethoxy-3-isopentoxy-propane, 2-cyclohexyl-2-(3,3-difluoro-3-chloro-propyl)-1-ethoxy-3-methoxy-propane, 2-cyclohexyl-2-(3,3-difluoro-5-methylhexyl)-1-ethoxy-3-methoxy-propane, 2-cyclohexyl-2-(3,3-dichloro-5-methylhexyl)-1-ethoxy-3-methoxy-propane, 2-cyclohexyl-2-(3-chloro-3-isobutyl-5-methylhexyl)-1-ethoxy-3-methoxy-propane, 2-cyclohexyl-2-(3-bromo-3-isobutyl-5-methylhexyl)-1-ethoxy-3-propoxy-propane, 2-cyclohexyl-2-(3-fluoro-3-isobutyl-5-methylhexyl)-1-ethoxy-3-methoxy-propane, 2-cyclohexyl-2-(3-fluoro-3-isopentyl-6-methylheptyl)-1-ethoxy-3-methoxy-propane, 2-cyclohexyl-2-(3-chloro-3-isopentyl-6-methylheptyl)-1-ethoxy-3-methoxy-propane, 2-cyclohexyl-2-(3-bromo-3-isopentyl-6-methylheptyl)-1-ethoxy-3-methoxy-propane, 2-cyclohexyl-2-(3,3-diphenylbutyl)-1-ethoxy-3-methoxy-propane, 2-cyclohexyl-2-(3,3-diphenylpropyl)-1-ethoxy-3-methoxy-propane, 2-cyclohexyl-2-(3,3,3-triphenylpropyl)-1-ethoxy-3-methoxy-propane, 2-cyclohexyl-2-(3,3,3-tris(4-chlorophenyl) propyl)-1-ethoxy-3-methoxy-propane, 2-cyclohexyl-2-(3,3-dimethylbutyl)-1-ethoxy-3-methoxy-propane, 2-cyclohexyl-2-(3-methylpentyl)-1-ethoxy-3-methoxy-propane, 2-cyclohexyl-2-(3-ethylpentyl)-1-ethoxy-3-methoxy-propane, 2-cyclohexyl-2-(3,3-diethylpentyl)-1-ethoxy-3-methoxy-propane, 2-cyclohexyl-2-(3-isopropyl-4-methylpentyl)-1-ethoxy-3-methoxy-propane, 2-cyclohexyl-2-(3,3-diisopropyl-4-methylpentyl)-1-ethoxy-3-methoxy-propane, 2-cyclohexyl-2-(cyclohexylethyl)-1-methoxy-3-propoxy-propane, 2-cyclohexyl-2-(cyclopentylethyl)-1-ethoxy-3-methoxy-propane, 2-cyclohexyl-2-(phenethyl)-1-ethoxy-3-methoxy-propane, 2-cyclohexyl-2-(2-trimethylsilylethyl)-1-ethoxy-3-methoxy-propane, 2-cyclohexyl-2-(2-triisopropylsilylethyl)-1-allyloxy-3-methoxy-propane, 2-cyclohexyl-2-(2-triphenylsilylethyl)-1-ethoxy-3-methoxy-propane, 2-cyclohexyl-2-(2-methyldiphenylsilylethyl)-1-ethoxy-3-methoxy-propane, 2-cyclohexyl-2-(2-dimethylphenylsilylethyl)-1-ethoxy-3-methoxy-propane, 2-cyclohexyl-2-(2-(tris(4-chlorophenyl) silyl)ethyl)-1-ethoxy-3-isobutoxy-propane, 2-cyclohexyl-2-(2-(bis(4-chlorophenyl)(methyl) silyl)ethyl)-1-ethoxy-3-methoxy-propane, 2-(3-methylcyclohexyl)-2-isopentyl-1,3-dimethoxypropane, 2-(2-methylcyclohexyl)-2-(3,3-difluorobutyl)-1,3-dimethoxypropane, 2-(4-methylcyclohexyl)-2-(3,3-dibromobutyl)-1,3-dimethoxypropane, 2-(4-methylcyclohexyl)-2-(3,3-dichlorobutyl)-1,3-dimethoxypropane, 2-(2-methylcyclohexyl)-2-(3,3,3-trifluoropropyl)-1,3-dimethoxypropane, 2-(4-methylcyclohexyl)-2-(3,3,3-tribromopropyl)-1,3-dimethoxypropane, 2-(2-methylcyclohexyl)-2-(3,3,3-trichloropropyl)-1,3-dimethoxypropane, 2-(4-methylcyclohexyl)-2-(3,3-difluoropropyl)-1,3-dimethoxypropane, 2-(3-methylcyclohexyl)-2-(3,3-dibromopropyl)-1,3-dimethoxypropane, 2-(4-methylcyclohexyl)-2-(3,3-dichloropropyl)-1,3-dimethoxypropane, 2-(4-methylcyclohexyl)-2-(3,3-dichloro-3-fluoro-propyl)-1,3-diethoxypropane, 2-(2-methylcyclohexyl)-2-(3,3-dichloro-3-bromo-propyl)-1,3-dipropoxypropane, 2-(4-methylcyclohexyl)-2-(3,3-difluoro-3-bromo-propyl)-1,3-dibutoxypropane, 2-(4-methylcyclohexyl)-2-(3,3-difluoro-3-chloro-propyl)-1,3-dipropoxypropane, 2-(4-methylcyclohexyl)-2-(3,3-difluoro-5-2-(4-methylcyclohexyl)-2-(3,3-dichloro-5-methylhexyl)-1,3-methylhexyl)-1,3-diethoxypropane, dipropoxypropane, 2-(4-methylcyclohexyl)-2-(3-chloro-3-isobutyl-5-methylhexyl)-1,3-2-(4-methylcyclohexyl)-2-(3-bromo-3-isobutyl-5-methylhexyl)-1,3-2-(3-methylcyclohexyl)-2-(3-fluoro-3-isobutyl-5-methylhexyl)-1,3-2-(4-methylcyclohexyl)-2-(3-fluoro-3-isopentyl-6-methylheptyl)-1,3-2-(3-methylcyclohexyl)-2-(3-chloro-3-isopentyl-6-methylheptyl)-1,3-diisopentoxypropane, diethoxypropane, dipropoxypropane, diethoxypropane, dibutoxypropane, 2-(4-methylcyclohexyl)-2-(3-bromo-3-isopentyl-6-methylheptyl)-1,3-dipropoxypropane, 2-(4-methylcyclohexyl)-2-(3,3-diphenylbutyl)-1,3-dimethoxypropane, 2-(4-methylcyclohexyl)-2-(3,3-diphenylpropyl)-1,3-dimethoxypropane, 2-(4-methylcyclohexyl)-2-(3,3,3-triphenylpropyl)-1,3-dimethoxypropane, 2-(4-methylcyclohexyl)-2-(3,3,3-tris(4-chlorophenyl) propyl)-1-ethoxy-3-methoxy-propane, 2-(2-methylcyclohexyl)-2-(3,3-dimethylbutyl)-1,3-dimethoxypropane, 2-(4-methylcyclohexyl)-2-(3-methylpentyl)-1,3-dimethoxypropane, 2-(4-methylcyclohexyl)-2-(3-ethylpentyl)-1,3-dimethoxypropane. 2-(4-methylcyclohexyl)-2-(3,3-diethylpentyl)-1,3-dimethoxypropane, 2-(4-methylcyclohexyl)-2-(3-isopropyl-4-methylpentyl)-1,3-dimethoxypropane, 2-(4-methylcyclohexyl)-2-(3,3-diisopropyl-4-methylpentyl)-1,3-dimethoxypropane, 2-(4-methylcyclohexyl)-2-(cyclohexylethyl)-1,3-dimethoxypropane, 2-(3-methylcyclohexyl)-2-(cyclopentylethyl)-1,3-dimethoxypropane, 2-(4-methylcyclohexyl)-2-(phenethyl)-1,3-dimethoxypropane, 2-(3-methylcyclohexyl)-2-(2-trimethylsilylethyl)-1,3-dimethoxypropane, 2-(3-methylcyclohexyl)-2-(2-triisopropylsilylethyl)-1,3-dimethoxypropane, 2-(4-methylcyclohexyl)-2-(2-triphenylsilylethyl)-1,3-dimethoxypropane, 2-(4-methylcyclohexyl)-2-(2-methyldiphenylsilylethyl)-1-ethoxy-3-methoxy-propane, 2-(4-methylcyclohexyl)-2-(2-dimethylphenylsilylethyl)-1-ethoxy-3-methoxy-propane, 2-(4-methylcyclohexyl)-2-(2-(tris(4-chlorophenyl) silyl)ethyl)-1-ethoxy-3-isobutoxy-propane, 2-(3-methylcyclohexyl)-2-(2-(bis(4-chlorophenyl)(methyl) silyl)ethyl)-1-ethoxy-3-methoxy-propane, 2-(3,5-dimethylcyclohexyl)-2-isopentyl-1,3-dimethoxypropane, 2-(4-(tert-butyl)cyclohexyl)-2-(3,3-difluorobutyl)-1,3-dimethoxypropane, 2-(2-isopropyl-5-methylcyclohexyl)-2-(3,3-dibromobutyl)-1,3-dimethoxypropane, 2-(2-isopropyl-5-methylcyclohexyl)-2-(3,3-dichlorobutyl)-1,3-dimethoxypropane, 2-(4-(tert-butyl)cyclohexyl)-2-(3,3,3-trifluoropropyl)-1,3-dimethoxypropane, 2-(2-isopropyl-5-methylcyclohexyl)-2-(3,3,3-tribromopropyl)-1,3-dimethoxypropane, 2-cyclohexyl-2-(3,4-dimethylpentyl)-1,3-dimethoxypropane, 2-cyclohexyl-2-(3,4,4-trimethylpentyl)-1,3-dimethoxypropane, 2-cyclohexyl-2-(3,5-dimethylhexyl)-1,3-dimethoxypropane, 2-cyclohexyl-2-(3-cyclopropylbutyl)-1,3-dimethoxypropane, 2-cyclohexyl-2-(3,3-dicyclohexylpropyl)-1,3-dimethoxypropane, 2-cyclohexyl-2-(3-phenylbutyl)-1,3-dimethoxypropane, 2-cyclohexyl-2-(3-methyl-4,4,4-trifluorobutyl)-1,3-dimethoxypropane, 2-cyclohexyl-2-(3-trifluoromethyl-4,4,4-trifluorobutyl)-1,3-dimethoxypropane, 2-cyclohexyl-2-(3-benzyl-4,4,4-trifluorobutyl)-1,3-dimethoxypropane, 2-cyclohexyl-2-((2,6-dimethyl)cyclohexylethyl)-1,3-dimethoxypropane, 2-cyclohexyl-2-((3,3,5-trimethyl)cyclohexylethyl)-1,3-dimethoxypropane, 2-cyclohexyl-2-(2-(1,7,7-trimethylbicyclo[3.1.1]heptan-6-yl)ethyl)-1,3-dimethoxypropane, 2-cyclohexyl-2-(3,3-dibenzylpropyl)-1,3-dimethoxypropane, 2-cyclohexyl-2-(9-fluorenylethyl)-1,3-dimethoxypropane, 2-(4-methylcyclohexyl)-2-isopentyl-1,3-dimethoxypropane, 2-cyclohexyl-2-(3-methylhexyl)-1,3-dimethoxypropane, 2-(4-methylcyclohexyl)-2-(3-methylhexyl)-1,3-dimethoxypropane, 2-cyclohexyl-2-(3,3,3-triphenylpropyl)-1,3-dimethoxypropane, 2-(4-(tert-butyl)cyclohexyl)-2-(3,3,3-trichloropropyl)-1,3-dimethoxypropane, 2-(2-isopropyl-5-methylcyclohexyl)-2-(3,3-difluoropropyl)-1,3-dimethoxypropane, 2-(3,5-dimethylcyclohexyl)-2-(3,3-dibromopropyl)-1,3-dimethoxypropane, 2-(2-isopropyl-5-methylcyclohexyl)-2-(3,3-dichloropropyl)-1,3-dimethoxypropane, 2-(2-isopropyl-5-methylcyclohexyl)-2-(3,3-dichloro-3-fluoro-propyl)-1,3-diethoxypropane, 2-(4-(tert-butyl)cyclohexyl)-2-(3,3-dichloro-3-bromo-propyl)-1,3-dipropoxypropane, 2-(2-isopropyl-5-2-(2-isopropyl-5-methylcyclohexyl)-2-(3,3-difluoro-3-bromo-propyl)-1,3-dibutoxypropane, 2-(2-isopropyl-5-methylcyclohexyl)-2-(3,3-difluoro-3-chloro-propyl)-1,3-dipropoxypropane, 2-(2-isopropyl-5-methylcyclohexyl)-2-(3,3-difluoro-5-methylhexyl)-1,3-diethoxypropane, 2-(2-isopropyl-5-methylcyclohexyl)-2-(3,3-dichloro-5-methylhexyl)-1,3-dipropoxypropane, methylcyclohexyl)-2-(3-chloro-3-isobutyl-5-methylhexyl)-1,3-diisopentoxypropane, 2-(2-isopropyl-5-methylcyclohexyl)-2-(3-bromo-3-isobutyl-5-methylhexyl)-1,3-diethoxypropane, 2-(3,5-dimethylcyclohexyl)-2-(3-fluoro-3-isobutyl-5-methylhexyl)-1,3-dipropoxypropane, 2-(2-isopropyl-5-methylcyclohexyl)-2-(3-fluoro-3-isopentyl-6-methylheptyl)-1,3-diethoxypropane, 2-(3,5-dimethylcyclohexyl)-2-(3-chloro-3-isopentyl-6-methylheptyl)-1,3-dibutoxypropane, 2-(2-isopropyl-5-methylcyclohexyl)-2-(3-bromo-3-isopentyl-6-methylheptyl)-1,3-dipropoxypropane, 2-(2-isopropyl-5-methylcyclohexyl)-2-(3,3-diphenylbutyl)-1,3-dimethoxypropane, 2-(2-isopropyl-5-methylcyclohexyl)-2-(3,3-diphenylpropyl)-1,3-dimethoxypropane, 2-(2-isopropyl-5-methylcyclohexyl)-2-(3,3,3-triphenylpropyl)-1,3-dimethoxypropane, 2-(2-isopropyl-5-methylcyclohexyl)-2-(3,3,3-tris(4-chlorophenyl) propyl)-1-ethoxy-3-methoxy-propane, 2-(4-(tert-butyl)cyclohexyl)-2-(3,3-dimethylbutyl)-1,3-dimethoxypropane, 2-(2-isopropyl-5-methylcyclohexyl)-2-(3-methylpentyl)-1,3-dimethoxypropane, 2-(2-isopropyl-5-methylcyclohexyl)-2-(3-ethylpentyl)-1,3-dimethoxypropane, 2-(2-isopropyl-5-methylcyclohexyl)-2-(3,3-diethylpentyl)-1,3-dimethoxypropane, 2-(2-isopropyl-5-methylcyclohexyl)-2-(3-isopropyl-4-methylpentyl)-1,3-dimethoxypropane, 2-(2-isopropyl-5-methylcyclohexyl)-2-(3,3-diisopropyl-4-methylpentyl)-1,3-dimethoxypropane, 2-(2-isopropyl-5-methylcyclohexyl)-2-(cyclohexylethyl)-1,3-dimethoxypropane, 2-(3,5-dimethylcyclohexyl)-2-(cyclopentylethyl)-1,3-dimethoxypropane, 2-(2-isopropyl-5-methylcyclohexyl)-2-(phenethyl)-1,3-dimethoxypropane, 2-(3,5-dimethylcyclohexyl)-2-(2-trimethylsilylethyl)-1,3-dimethoxypropane, 2-(3,5-dimethylcyclohexyl)-2-(2-triisopropylsilylethyl)-1,3-dimethoxypropane, 2-(2-isopropyl-5-methylcyclohexyl)-2-(2-triphenylsilylethyl)-1,3-dimethoxypropane, 2-(2-isopropyl-5-methylcyclohexyl)-2-(2-methyldiphenylsilylethyl)-1-ethoxy-3-methoxy-propane, 2-(2-isopropyl-5-methylcyclohexyl)-2-(2-dimethylphenylsilylethyl)-1-ethoxy-3-methoxy-propane, 2-(2-isopropyl-5-methylcyclohexyl)-2-(2-(tris(4-chlorophenyl) silyl)ethyl)-1-ethoxy-3-isobutoxy-propane, and 2-(3,5-dimethylcyclohexyl)-2-(2-(bis(4-chlorophenyl)(methyl) silyl)ethyl)-1-ethoxy-3-methoxy-propane.

In some embodiments, the molar ratio between the electron donor of formula (I) and the Ti atoms in the final solid catalyst component ranges from 0.3:1 to 1.5:1, alternatively from 0.4:1 to 1.3:1.

In some embodiments, the molar ratio between the Mg atoms and the electron donor of formula (I) in the final solid catalyst component ranges from 2.5:1 to 50.0:1, alternatively 3:1 to 45.0:1, alternatively 5.0:1 to 30.0:1, alternatively from 6.0:1 to 25.0:1.

In some embodiments, additional electron donors are present in the catalyst component. In some embodiments, the additional electron donors are selected from mono or diesters of aromatic or aliphatic carboxylic acids. In some embodiments, the additional electron donors are selected from esters of aliphatic dicarboxylic acids. In some embodiments, the esters of aliphatic dicarboxylic acids are selected from the group consisting of malonates, succinates, and glutarates as described in Patent Cooperation Treaty Publication No. WO99/57160 . . . . In some embodiments, the additional electron donors are present in an amount from 0.1 to up less than 50.0% mol, alternatively from 0.5 to 45.0% mol, based on the total molar amount of difunctional electron donors. In some embodiments, the additional donor is different from esters of aliphatic dicarboxylic acids and present in an amount less than 10% mol, alternatively less than 8% mol, based on the total molar amount of electron donors.

In some embodiments, the solid catalyst component has a porosity, determined by mercury method, relating to pore with radius equal to or less than 1 μm of at least 0.20 cm³/g. In some embodiments, the porosity is higher than 0.30 cm³/g, alternatively higher than 0.40 cm³/g.

In some embodiments, the catalyst component has an average particle size ranging from 20 to 150 μm, alternatively from 40 to 100 μm.

In some embodiments, the catalyst component is made from or containing the electron donors, a titanium compound having at least a Ti-halogen bond, and a Mg halide. In some embodiments, the titanium compounds are selected from the group consisting of TiCl₄ and TiCl₃. In some embodiments, the titanium compounds are Ti-haloalcoholates of formula Ti(OR⁵)_{n-y}X_{y}, wherein n is the valence of titanium, y is a number between 1 and n-1, X is halogen and R⁵ is a hydrocarbon radical having from 1 to 10 carbon atoms.

In some embodiments, the solid catalyst component is prepared by reacting a titanium compound of formula Ti(OR⁵)_{m-y}X_{y}, wherein m is the valence of titanium and y is a number between 1 and m, with a magnesium chloride deriving from an adduct of formula MgCl₂·pR⁶OH, wherein p is a number between 0.1 and 6, alternatively from 2 to 3.5, and R⁶ is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80-130° C.), thereby obtaining an adduct in which the number of moles of alcohol is lower than 3, alternatively between 0.1 and 2.5, alternatively between 0.5 and 2.3.

In some embodiments, the catalyst made from or containing the electron donor of formula (I), is prepared starting from highly dealcoholated adducts. In some embodiments, highly dealcoholated adducts have a number of mole of alcohol per mole of Mg lower than 2.

In some embodiments and for preparing the catalyst, the reaction with the Ti compound is carried out by suspending the adduct (dealcoholated or as such) in cold TiCl₄. In some embodiments, the cold TiCl₄ is at 0° C. In some embodiments, the adduct is used in an amount such as to have a concentration ranging from 20 to 100 g/l, alternatively from 30 to 90 g/l. In some embodiments, the electron donor (I) is added to the system at the beginning of this stage of reaction. In some embodiments, the temperature of the mixture is in the range of 10° C. to 60° C. In some embodiments, the Mg/donor (I) molar ratio ranges from 2:1 to 25:1, alternatively from 2:1 to 25:1, alternatively from 2:1 to 15:1, alternatively from 3:1 to 10:1. In some embodiments, the temperature is then gradually raised up until reaching a temperature ranging from 90-130° C. and kept at this temperature for 0.5-3 hours.

After completing the reaction time, stirring is stopped. The slurry is allowed to settle. The liquid phase is removed. A second stage of treatment with TiCl₄ is performed. In some embodiments, the second stage is carried out at a temperature ranging from 70 to 130° C. After completing the reaction time, stirring is stopped. The slurry is allowed to settle. The liquid phase is removed. In some embodiments, an additional reaction stage with the titanium compound is carried out. In some embodiments, the titanium compound is TiCl₄. In some embodiments, the conditions are the same as described above. In some embodiments, the additional reaction stage occurs in the absence of electron donors. In some embodiments, the resulting solid is washed with liquid hydrocarbon under mild conditions and then dried.

In some embodiments, the catalyst made from or containing the electron donor of formula (I) is prepared with Mg/ID molar ratios in the range of 13-20 and the amount of ID fixed on the catalyst such that the molar ratio ID/Ti is in the range of 0.3-0.6.

In some embodiments, the solid catalyst component contains a small amount of additional metal compounds made from or containing elements belonging to groups 1-15, alternatively groups 11-15, of the periodic table of elements (IUPAC version).

In some embodiments, the additional metal compounds free of metal-carbon bonds and are made from or containing elements selected from the group consisting of Cu, Zn, and Bi. In some embodiments, the additional metal compounds are selected from the group consisting of oxides, carbonates, alkoxylates, carboxylates, and halides of the metals. In some embodiments, the additional metal compounds are selected from the group consisting of ZnO, ZnCl₂, CuO, CuCl₂, Cu diacetate, BiCl₃. Bi carbonates, and Bi carboxylates. In some embodiments, the additional metal compounds are selected from the group consisting of BiCl₃. Bi carbonates and Bi carboxylates.

In some embodiments, the additional metal compounds are added either during the preparation of the magnesium-alcohol adduct or by dispersion into the titanium compound in liquid form, which is then reacted with the adduct.

In some embodiments, the final amount of the metals in the final catalyst component ranges from 0.1 to 10% wt, alternatively from 0.3 to 8% wt, alternatively from 0.5 to 5% wt, with respect to the total weight of solid catalyst component.

In some embodiments, the solid catalyst components are converted into catalysts for the polymerization of olefins by reacting with organoaluminum compounds.

In some embodiments, the present disclosure provides a catalyst for the polymerization of olefins CH₂═CHR, wherein R is hydrogen or a hydrocarbon radical with 1-12 carbon atoms, made from or containing the product of the reaction between:
(i) the solid catalyst component and
(ii) an alkylaluminum compound and, optionally,
(iii) an external electron donor compound.

In some embodiments, the alkyl-Al compound (ii) is a trialkyl aluminum compound. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the alkyl-Al compound (ii) is selected from the group consisting of alkylaluminum halides, alkylaluminum hydrides, alkylaluminum sesquichlorides, and mixtures with trialkylaluminum compounds. In some embodiments, the alkylaluminum sesquichlorides is AlEt₂Cl or Al₂Et₃Cl₃.

In some embodiments, the catalyst component provides a highly stereoregular polypropylene. In some embodiments, the catalyst component provides a highly stereoregular polypropylene in the absence of an external donor. In some embodiments, the amount of xylene insoluble fraction is higher than 97.5% wt, alternatively higher than 98% wt. In some embodiments and with polymerizing in liquid propylene at 70° C. for two hours, the polymerization activity is higher than 100 kgₚₒₗ/g_{cat}, alternatively higher than 115 kgₚₒₗ/g_{cat}, alternatively higher than 130 kgₚₒₗ/g_{cat}.

In some embodiments, external electron-donor compounds (iii) are selected from the group consisting of silicon compounds, ethers, esters, amines, heterocyclic compounds, and ketones. In some embodiments, the heterocyclic compound is 2,2,6,6-tetramethylpiperidine.

In some embodiments, the external donor compounds are silicon compounds of formula (R⁷)ₐ(R⁸)_{b}Si(OR⁹)_{c}, where a and b are integers from 0 to 2, c is an integer from 1 to 4 and the sum (a+b+c) is 4; R⁷, R⁸, and R⁹, are alkyl, cycloalkyl or aryl radicals with 1-18 carbon atoms optionally containing heteroatoms. In some embodiments, the external donor compounds are silicon compounds wherein a is 1, b is 1, c is 2, at least one of R⁷ and R⁸ is selected from branched alkyl, cycloalkyl or aryl groups with 3-10 carbon atoms optionally containing heteroatoms and R⁹ is a C₁-C₁₀ alkyl group. In some embodiments, R⁹ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl) t-butyldimethoxysilane, (2-ethylpiperidinyl) thexyldimethoxysilane, (3,3,3-trifluoro-n-propyl) (2-ethylpiperidinyl)dimethoxysilane, and methyl (3,3,3-trifluoro-n-propyl)dimethoxysilane. In some embodiments, the external donor compounds are silicon compounds wherein a is 0, c is 3, R⁸ is a branched alkyl or cycloalkyl group, optionally containing heteroatoms, and R⁹ is methyl. In some embodiments the silicon compounds are selected from the group consisting of cyclohexyltrimethoxysilane, t-butyltrimethoxysilane and thexyltrimethoxysilane.

In some embodiments, the amount of external electron donor compound (iii) provides a molar ratio between the organoaluminum compound and the electron donor compound (iii) of from 0.1:1 to 500:1, alternatively from 1:1 to 300:1, alternatively from 3:1 to 100:1.

In some embodiments, the present disclosure provides a process for the homopolymerization or copolymerization of olefins CH₂—CHR, wherein R is hydrogen or a hydrocarbon radical with 1-12 carbon atoms, carried out in the presence of a catalyst made from or containing the product of the reaction between:
(i) the solid catalyst component;
(ii) an alkylaluminum compound and,
(iii) optionally an electron-donor compound (external donor).

In some embodiments, the polymerization process is carried out in a slurry polymerization using as diluent an inert hydrocarbon solvent, or in bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, the catalyst is used as such in the polymerization process by introducing the catalyst directly into the reactor. In some embodiments, the catalyst is pre-polymerized before being introduced into the first polymerization reactor. As used herein, the term “pre-polymerized” refers to a catalyst which has been subjected to a polymerization step at a low conversion degree. In some embodiments, a catalyst is considered to be pre-polymerized when the amount the polymer produced is from about 0.1 up to about 1000 g per gram of solid catalyst component.

In some embodiments, the pre-polymerization is carried out with the α-olefins selected from the same group of olefins. In some embodiments, pre-polymerizing involves ethylene or mixtures thereof with one or more α-olefins in an amount up to 20% by mole. In some embodiments, the conversion of the pre-polymerized catalyst component is from about 0.2 g up to about 500 g per gram of solid catalyst component.

In some embodiments, the pre-polymerization step is carried out at temperatures from 0° to 80° C., alternatively from 5° to 50° C., in liquid or gas-phase. In some embodiments, the pre-polymerization step is performed in-line as a part of a continuous polymerization process or separately in a batch process. In some embodiments, batch pre-polymerization of the catalyst with ethylene produces an amount of polymer ranging from 0.5 to 20 g per gram of catalyst component.

In some embodiments, the polymerization is carried out at temperature ranging from 20 to 120° C., alternatively from 40 to 80° C. In some embodiments, the polymerization is carried out in gas-phase with an operating pressure between 0.5 and 5 MPa, alternatively between 1 and 4 MPa. In some embodiments, the polymerization is carried out in a bulk polymerization with the operating pressure between 1 and 8 MPa, alternatively between 1.5 and 5 MPa.

In some embodiments, the alpha-olefins for polymerization are selected from the group consisting of ethylene, propylene, 1-butene, 4-methyl-1-pentene, and 1-hexene. In some embodiments, the catalysts are used in the homopolymerization or copolymerization of propylene and ethylene. In some embodiments, the resulting polymers are propylene homopolymers or copolymers. In some embodiments, the resulting polymers are selected from the group consisting of low xylene soluble content propylene/ethylene copolymers and high purity polypropylene polymers having a very low content of halogen (Cl) and metals like Ti, Mg and Al. In some embodiments, the resulting propylene/ethylene copolymers have an ethylene content ranging from 0.1 to 6% wt, based on the total weight of propylene and ethylene.

In some embodiments, the catalysts yield high impact resistance polymer compositions made from or containing (A) a crystalline propylene homo or copolymer matrix and a substantial amount of (B) a low crystallinity, highly soluble in xylene, propylene-ethylene based copolymer. In some embodiments, a substantial amount is more than 50% wt.

In some embodiments, the polymer compositions are prepared in a multistep process including at least two different polymerization stages carried out in different reactors. In some embodiments and in the first step, wherein the crystalline propylene homopolymer or copolymer is prepared, is carried out either in gas-phase or in liquid phase. In some embodiments, the gas-phase polymerization is carried out in a fluidized or stirred, fixed bed reactor or in a gas-phase reactor including two interconnected polymerization zones. In some embodiments, the polymer flows under fast fluidization conditions in the first of the two interconnected polymerization zones. In some embodiments, the polymer flows under the action of gravity in the second polymerization zone. In some embodiments, the liquid phase process is in slurry, solution, or bulk (liquid monomer). In some embodiments, the liquid phase process is carried out in various types of reactors. In some embodiments, the reactors are continuous stirred tank reactors, loop reactors, or plug-flow reactors. In some embodiments, the first step is carried out in gas-phase. In some embodiments and in a stage or a successive stage, hydrogen is used as a molecular weight regulator.

In some embodiments and in the second stage of the polymerization process, the propylene-ethylene copolymer (B) is produced in a fluidized-bed gas-phase reactor in the presence of the polymeric material and the catalyst system coming from the preceding polymerization step.

In some embodiments, the polymer produced in the stage is made from or containing 15 to 75% wt of ethylene, optionally containing minor proportions of a diene. In some embodiments, the polymer's solubility in xylene at 25° C. is at least 60% wt.

The following examples are given to illustrate and not to limit the disclosure.

### Characterization

### Determination of Porosity.

Porosity and surface area with mercury: the measurement was carried out using a Pascal 140-240 series porosimeter by Carlo Erba.

The porosity was determined by intrusion of mercury under pressure. For this determination, a calibrated dilatometer (capillary diameter 3 mm) CD₃P (by Carlo Erba) was used, which was connected to a reservoir of mercury and a high-vacuum pump. A weighed amount of sample was placed in the dilatometer. The apparatus was then placed under high vacuum and maintained in these conditions for about 20 minutes. The dilatometer was then connected to the mercury reservoir. The mercury filled the dilatometer to the level marked on the dilatometer at a height of 10 cm. The valve that connected the dilatometer to the vacuum pump was closed. The mercury pressure was gradually increased with nitrogen up to 100 kPa. The calibrated dilatometer was transferred into an autoclave with oil for high pressure to reach pressure values up to 200 MPa. Under the effect of the pressure, the mercury entered into the pores of the particles. The mercury level decreased accordingly. The porosity (cm³/g), the pore distribution curve, and the average pore size were directly calculated from the integral pore distribution curve, which was a function of both the volume reduction of the mercury and the applied pressure values. After calculation, the average pores radius was given as the weighted average of the single average pores radius contribution for each interval of porosity.

### Determination of X.I.

About 2.5 grams of polymer and 250 ml of o-xylene were placed in a round-bottom flask, provided with a cooler and a reflux condenser, and kept under nitrogen. The resulting mixture was heated to 135° C. and kept under stirring for about 60 minutes. The final solution was cooled to 25° C. under continuous stirring. The insoluble polymer was then filtered. The filtrate was evaporated in a nitrogen flow at 140° C. to reach a constant weight. The content of xylene-soluble fraction was expressed as a percentage of the original 2.5 grams and then, by difference, the X.I. %.

### Determination of Donors.

The content of electron donor was determined via gas-chromatography.

### Determination of Melt Flow Rate (MFR).

The melt flow rate MIL of the polymer was determined according to ISO 1133 (230° C., 2.16 Kg).

### Determination of Comonomer.

The content of comonomer (ethylene) was determined via NMR spectroscopy.

### Determination of Tm

Determined by differential scanning calorimetry (DSC). A sample, weighing 6±1 mg, was heated to 220±1° C. at a rate of 20° C./min and kept at 220±1° C. for 2 minutes in nitrogen stream. Thereafter, the sample was cooled at a rate of 20° C./min to 40±2° C. The sample was maintained at this temperature for 2 min, thereby permitting the sample to crystallize. Then, the sample was again fused at a temperature rise rate of 20° C./min up to 220° C.±1. The melting scan was recorded. A thermogram was obtained. The melting temperatures and crystallization temperatures were read.

### Determination of Intrinsic Viscosity (I.V.)

On the xylene soluble fraction, the Intrinsic Viscosity was measured. The sample was dissolved in tetrahydronaphthalene at 135° C. and then poured into the capillary viscometer. The viscometer tube (Ubbelohde type) was surrounded by a cylindrical glass jacket, which permitted temperature control with a circulating thermostatic liquid. The downward passage of the meniscus was timed by a photoelectric device.

The passage of the meniscus in front of the upper lamp started the counter, which had a quartz crystal oscillator. The counter stopped as the meniscus passed the lower lamp. The efflux time was registered and converted into a value of intrinsic viscosity through Huggins equation (Huggins, M. L., J. Am. Chem. Soc., 1942, 64, 2716), using the flow time of the solvent at the same experimental conditions (same viscometer and same temperature). A single polymer solution was used to determine [η].

### Determination of Flexural Modulus

Flexural Modulus was measured according to ISO 178 and ISO 1873-2

### Determination of Tensile Modulus

Tensile Modulus was measured according to ISO 527 and ISO 1873-2

### Determination of Charpy

Charpy impact test according to ISO 179-1eA, and ISO 1873-2

### Determination of 13C NMR Spectra of Propylene/Ethylene Copolymers

The 13C NMR spectra of the heterophasic copolymers and of the XI and XS fractions were acquired on a Bruker AV-600 spectrometer equipped with cryoprobe, operating at 160.91 MHz in the Fourier transform mode at 120° C.

The peak of the SBB carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d₂ at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{ββ} / S \qquad PPE = 100 {T}_{βδ} / S \qquad EPE = 100 {T}_{δδ} / S$$

$$PEP = 100 {S}_{ββ} / S \qquad PEE = 100 {S}_{βδ} / S \qquad EEE = 100 ( 0.25 {S}_{γδ} + 0.5 {S}_{δδ} ) / S$$

$$S = {T}_{β β} + {T}_{β δ} + {T}_{δ δ} + {S}_{β β} + {S}_{β δ} + 0.25 {S}_{γδ} + 0.5 {S}_{δδ}$$

The molar percentage of ethylene content was evaluated using the following equation:

$$E \% mol = 100 \times [ PEP + PEE + EEE ]$$

The weight percentage of ethylene content was evaluated using the following equation:

$$E \% w t = 100 \times M {W}_{E} \times E \% mol / ( M {W}_{E} \times E \% mol + M {W}_{P} \times P \% mol )$$

where P % mol is the molar percentage of propylene content, while MWE and MWp are the molecular weights of ethylene and propylene, respectively.

### EXAMPLES

General procedure for the preparation of MgCl₂*pEtOH adducts.

An initial amount of microspheroidal MgCl₂*2.8EtOH was prepared according to the method described in Example 2 of U.S. Pat. No. 4,399,054 but operating at 3,000 rpm instead of 10,000. A portion of the resulting adduct was subjected to thermal dealcoholation at increasing temperatures from 30 to 130° C., operating in nitrogen current, until the molar alcohol content per mol of Mg was 2.1.

### Preparation of electron donors

### Synthesis of 2-cyclohexyl-2-isopentyl-1,3-dimethoxypropane

### Step 1: synthesis of diethyl 2-cyclohexylmalonate

To a 1 L round bottom flask, equipped with mechanical stirrer, thermometer, and condenser, was added ethanol (400 mL) and potassium tert-butoxide (50 g, 0.4 mol). Successively, diethylmalonate (63 g, 0.4 mol) was added dropwise in 10 minutes, observing the formation of a white suspension. The temperature was raised to 76° C. Cyclohexyl bromide was added over a period of 30 minutes. The mixture was left at reflux for 40 hours. The solvent was removed under vacuum. The slurry was recovered with ethyl acetate (200 mL). The organic phase was washed with water (2×100 mL) and 10% NaHCO₃, then evaporated, thereby leading to 26 g of diethyl 2-cyclohexylmalonate as a light yellow oil, purity 99% (GC), yield 27%. ¹HNMR (δ, 400 MHZ, CDCl₃): 4.2 (q, 4H, OCH₂), 3.2 (d, 1H, CH malonic), 2.1 (m, 1H, CH cyclohexyl), 1.8-0.8 (m, 16H, OCH₂CH₃+cyclohexyl.

### Step 2: synthesis of diethyl 2-cyclohexyl-2-isopentylmalonate

To a 500 mL round bottom flask, equipped with mechanical stirrer, thermometer, and condenser, was added tetrahydrofuran (120 mL), diethyl 2-cyclohexylmalonate (26 g, 105 mmol), and sodium hydride (95%, 3 g, 119 mmol). The temperature was raised to 40° C., observing the formation of gas. After 1 hour, the gas evolution disappeared. Isopentyl bromide (20 g, 130 mmol) was added over a period of 30 minutes. The mixture was left at reflux for 25 hours, then diluted with 300 mL of HCl 1 M. The organic phase was diluted with diethyl ether (200 mL), washed with water (2×100 mL), and then evaporated, thereby leading to 23 g of diethyl 2-cyclohexyl-2-isopentylmalonate as a light yellow oil, purity 95% (GC), yield 67%. ¹HNMR (δ, 400 MHZ, CDCl₃): 4.1 (q, 4H, OCH₂), 1.7 (m, 3H, CH cyclohexyl+α-CH₂ isopentyl), 1.6-1.3 (m, 8H, cyclohexyl), 1.2 (m, 7H, OCH₂CH₃+γ-CH isopentyl), 1.0 (m, 4H, cyclohexyl+β-CH₂ isopentyl), 0.8 (d, 6H, (CH₃)₂ isopentyl).

### Step 3: synthesis of 2-cyclohexyl-2-isopentyl-1,3-propandiol

To a 500 mL round bottom flask, equipped with mechanical stirrer, thermometer, and condenser, was added tetrahydrofuran (100 mL), diethyl 2-cyclohexyl-2-isopentylmalonate (95%, 23 g, 70 mmol), and lithium aluminum hydride (95%, 3 g, 77 mmol). The mixture was left at reflux for 16 hours, then diluted with 200 mL of HCl 1 M. The organic phase was extracted with diethyl ether (200 mL), washed with water (2×100 mL), and then evaporated, thereby leading to 15 g of 2-cyclohexyl-2-isopentylmalonate-1,3-propandiol as colorless viscous oil, purity 98% (GC), yield 92%. ¹HNMR (δ, 400 MHZ, CDCl₃): 4.9-4.6 (dd, 4H, OCH₂), 2.2 (s, 2H, OH), 1.9-1.1 (m, 16H, cyclohexyl+isopentyl), 0.9 (d, 6H, (CH₃)₂ isopentyl).

### Step 4: synthesis of 2-cyclohexyl-2-isopentyl-1,3-dimethoxypropane

To a 500 mL round bottom flask, equipped with mechanical stirrer, thermometer and condenser, was added tetrahydrofuran (70 mL), 2-cyclohexyl-2-isopentyl-1,3-propandiol (98%, 15 g, 64 mmol), and sodium hydride (95%, 3 g, 128 mmol). The temperature was raised to 40° C. (gas evolution). Methyl iodide (20 g, 141 mmol) was added dropwise in 1 hour. Successively, the slurry was left at 40° C. for 8 hours, then diluted with 200 mL of HCl 1 M. The organic phase was diluted with diethyl ether (100 mL), washed with water (2×50 mL), and then evaporated, thereby leading to 16 g of 2-cyclohexyl-2-isopentyl-1,3-dimethoxypropane as a colorless oil, purity 99% (GC), yield 98%. ¹HNMR (δ, 400 MHZ, CDCl₃): 3.2 (s, 6H, CH₃O), 3.1 (s, 4H, OCH₂), 1.8-1.0 (m, 16H, cyclohexyl+isopentyl), 0.8 (d, 6H, (CH₃)₂ isopentyl).

### Synthesis of 2-cyclohexyl-2-(3,3,3-trifluoro-n-propyl)-1,3-dimethoxypropane

### Step 1: synthesis of diethyl 2-cyclohexyl-2-(3,3,3-trifluoro-n-propyl) malonate

This derivative was prepared according to the synthesis described in Example 1-step 2, using 1-iodo-3,3,3-trifluoro-n-propane as alkylating agent. The product was a light yellow oil with a purity of 97%, yield 50%. ¹HNMR (δ, 400 MHZ, CDCl₃): 4.2 (q, 4H, OCH₂), 2.2-1.5 (m, 10H, cyclohexyl+3,3,3-trifluoro-n-propyl), 1.2 (t, 6H, OCH₂CH₃), 1.1-0.9 (m, 5H, cyclohexyl+3,3,3-trifluoro-n-propyl).

### Step 2: synthesis of 2-cyclohexyl-2-(3,3,3-trifluoro-n-propyl)-1,3-propandiol

This derivative was prepared according to the synthesis described in Example 1-step 3. The product was an orange viscous oil with a purity of 98.5%, yield 92%. ¹HNMR (δ, 400 MHZ, CDCl₃): 3.7-3.5 (dd, 4H, OCH₂), 2.5 (s, 2H, OH), 2.0 (m, 2H, β-CH₂ 3,3,3-trifluoro-n-propyl), 1.8-0.9 (m, 13H, cyclohexyl+3,3,3-trifluoro-n-propyl).

### Step 3: synthesis of 2-cyclohexyl-2-(3,3,3-trifluoro-n-propyl)-1,3-dimethoxypropane

This derivative was prepared according to the synthesis described in Example 1-step 4. The product was a yellow oil with a purity of 98%, yield 95%, ¹HNMR (δ, 400 MHZ, CDCl₃): 3.2 (s, 6H, CH₃O), 3.1 (s, 4H, OCH₂), 2.1 (m, 2H, β-CH₂ 3,3,3-trifluoro-n-propyl), 1.8-0.9 (m, 13H, cyclohexyl+3,3,3-trifluoro-n-propyl).

### Synthesis of 2-cyclohexyl-2-(3-methylpentyl)-1,3-dimethoxypropane

### Step 1: synthesis of diethyl 2-cyclohexyl-2-(3-methylpentyl) malonate

This derivative was prepared according to the synthesis described in Example 1-step 2, using 1-bromo-3-methylpentane as alkylating agent. The product was a colorless oil with a purity of 92%, yield 82%. ¹HNMR (δ, 400 MHZ, CDCl₃): 4.2 (q, 4H, OCH₂), 2.1-1.5 (m, 8H, cyclohexyl+3-methylpentyl), 1.3 (t, 6H, OCH₂CH₃), 1.2-0.8 (m, 16H, cyclohexyl+3-methylpentyl).

### Step 2: synthesis of 2-cyclohexyl-2-(3-methylpentyl)-1,3-propandiol

This derivative was prepared according to the synthesis described in Example 1-step 3. The product was a yellow viscous oil with a purity of 92%, yield 92%. ¹HNMR (δ, 400 MHZ, CDCl₃): 3.7-3.5 (dd, 4H, OCH₂), 2.7 (s, 2H, OH), 1.6-0.8 (m, 24H, cyclohexyl+3-methylpentyl).

### Step 3: synthesis of 2-cyclohexyl-2-(3-methylpentyl)-1,3-dimethoxypropane

This derivative was prepared according to the synthesis described in Example 1-step 4. The product was distilled with a Vigreaux apparatus at 145° C./6 mmHg, thereby obtaining a colorless oil with a purity of 96%, yield 81%. ¹HNMR (δ, 400 MHZ, CDCl₃): 3.3 (s, 6H, CH₃O), 3.2 (s, 4H, OCH₂), 1.8-1.0 (m, 18H, cyclohexyl+3-methylpentyl), 0.8 (m, 6H, 3-methylpentyl).

### Synthesis of Synthesis of 2-cyclohexyl-2-(3-ethylpentyl)-1,3-dimethoxypropane

### Step 1: synthesis of diethyl 2-cyclohexyl-2-(3-ethylpentyl) malonate

This derivative was prepared according to the synthesis described in Example 1-step 2, using 1-bromo-3-ethylpentane as alkylating agent. The product was a yellow oil with a purity of 87%, yield 77%. ¹HNMR (δ, 400 MHZ, CDCl₃): 4.2 (q, 4H, OCH₂), 2.1-1.5 (m, 8H, cyclohexyl+3-ethylpentyl), 1.2 (t, 6H, OCH₂CH₃), 1.1-0.8 (m, 18H, cyclohexyl+3-ethylpentyl).

### Step 2: synthesis of 2-cyclohexyl-2-(3-ethylpentyl)-1,3-propandiol

This derivative was prepared according to the synthesis described in Example 1-step 3. The product was a colorless viscous oil with a purity of 86%, yield 95%, ¹HNMR (δ, 400 MHZ, CDCl₃): 3.7-3.5 (dd, 4H, OCH₂), 2.2 (s, 2H, OH), 1.6-0.8 (m, 26H, cyclohexyl+3-ethylpentyl).

### Step 3: synthesis of 2-cyclohexyl-2-(3-ethylpentyl)-1,3-dimethoxypropane

This derivative was prepared according to the synthesis described in Example 1-step 4. The product was a colorless oil with a purity of 95%, yield 86%. ¹HNMR (δ, 400 MHZ, CDCl₃): 3.2 (s, 6H, CH₃O), 3.1 (s, 4H, OCH₂), 1.8-1.0 (m, 20H, cyclohexyl+3-ethylpentyl), 0.8 (m, 6H, 3-ethylpentyl)

### Synthesis of 2-cyclohexyl-2-(3,5-dimethylhexyl)-1,3-dimethoxypropane

### Step 1: synthesis of diethyl 2-cyclohexyl-2-(3,5-dimethylhexyl) malonate

This derivative was prepared according to the synthesis described in Example 1-step 2, using 1-bromo-3,5-dimethylhexane as alkylating agent. The product was a brown oil with a purity of 92%, yield 78%. ¹HNMR (δ, 400 MHZ, CDCl₃): 4.2 (q, 4H, OCH₂), 1.9-1.3 (m, 10H, cyclohexyl+3,5-dimethylhexyl), 1.2 (t, 6H, OCH₂CH₃), 1.1-0.8 (m, 8H, cyclohexyl+3,5-dimethylhexyl), 0.7 (m, 10H, 3,5-dimethylhexyl).

### Step 2: synthesis of 2-cyclohexyl-2-(3,5-dimethylhexyl)-1,3-propandiol

This derivative was prepared according to the synthesis described in Example 1-step 3. The product was a yellow viscous oil with a purity of 96%, yield 96%. ¹HNMR (δ, 400 MHZ, CDCl₃): 3.7-3.5 (dd, 4H, OCH₂), 2.3 (s, 2H, OH), 1.7-0.8 (m, 18H, cyclohexyl+3,5-dimethylhexyl), 0.7 (m, 10H, 3,5-dimethylhexyl).

### Step 3: synthesis of 2-cyclohexyl-2-(3,5-dimethylhexyl)-1,3-dimethoxypropane

This derivative was prepared according to the synthesis described in Example 1-step 4. The product was a colorless oil with a purity of 96%, yield 94%. ¹HNMR (δ, 400 MHZ, CDCl₃): 3.3 (s, 6H, CH₃O), 3.2 (s, 4H, OCH₂), 1.8-0.9 (m, 18H, cyclohexyl+3,5-dimethylhexyl), 0.7 (m, 10H, 3,5-dimethylhexyl).

### Synthesis of 2-cyclohexyl-2-n-pentyl-1,3-dimethoxypropane

### Step 1: synthesis of diethyl 2-cyclohexyl-2-n-pentylmalonate

This derivative was prepared according to the synthesis described in Example 1-step 2, using n-pentyl bromide as alkylating agent. The product was a light yellow oil with a purity of 90%, yield 80%. ¹HNMR (δ, 400 MHZ, CDCl₃): 4.1 (q, 4H, OCH₂), 1.9-1.6 (m, 8H, cyclohexyl+n-pentyl), 1.4-0.9 (m, 17H, OCH₂CH₃+cyclohexyl+n-pentyl), 0.8 (t, 3H, CH₃ n-pentyl).

### Step 2: synthesis of 2-cyclohexyl-2-n-pentyl-1,3-propandiol

This derivative was prepared according to the synthesis described in Example 1-step 3. The product was a colorless viscous oil with a purity of 98%, yield 75%, ¹HNMR (δ, 400 MHZ, CDCl₃): 3.9-3.7 (dd, 4H, OCH₂), 2.2 (s, 2H, OH), 1.8-1.0 (m, 19H, cyclohexyl+n-pentyl), 0.9 (t, 3H, CH₃ n-pentyl).

### Step 3: synthesis of 2-cyclohexyl-2-n-pentyl-1,3-dimethoxypropane

This derivative was prepared according to the synthesis described in Example 1-step 4. The product was a colorless oil with a purity of 98%, yield 96%. ¹HNMR (δ, 400 MHZ, CDCl₃): 3.3 (s, 6H, CH₃O), 3.2 (s, 4H, OCH₂), 1.8-1.0 (m, 19H, cyclohexyl+n-pentyl), 0.9 (t, 3H, CH₃ n-pentyl).

### Synthesis of 2-cyclohexyl-2-n-butyl-1,3-dimethoxypropane

### Step 1: synthesis of diethyl 2-cyclohexyl-2-n-butylmalonate

This derivative was prepared according to the synthesis described in Example 1-step 2, using n-butyl bromide as alkylating agent. The product was a light yellow oil with a purity of 96%, yield 79%. ¹HNMR (δ, 400 MHZ, CDCl₃): 4.1 (q, 4H, OCH₂), 1.9-1.6 (m, 8H, cyclohexyl+n-butyl), 1.4-0.9 (m, 15H, OCH₂CH₃+cyclohexyl+n-butyl), 0.8 (t, 3H, CH₃ n-butyl).

### Step 2: synthesis of 2-cyclohexyl-2-n-butyl-1,3-propandiol

This derivative was prepared according to the synthesis described in Example 1-step 3. The product was a colorless viscous oil with a purity of 99%, yield 85%, ¹HNMR (δ, 400 MHZ, CDCl₃): 3.9-3.7 (dd, 4H, OCH₂), 2.2 (s, 2H, OH), 1.8-1.0 (m, 17H, cyclohexyl+n-butyl), 0.9 (t, 3H, CH₃ n-butyl).

### Step 3: synthesis of 2-cyclohexyl-2-n-butyl-1,3-dimethoxypropane

This derivative was prepared according to the synthesis described in Example 1-step 4. The product was a colorless oil with a purity of 98%, yield 99%. ¹HNMR (δ, 400 MHZ, CDCl₃): 3.3 (s, 6H, CH₃O), 3.2 (s, 4H, OCH₂), 1.8-1.1 (m, 17H, cyclohexyl+n-butyl), 0.9 (t, 3H, CH₃ n-butyl).

### Synthesis of 2-cyclohexyl-2-isobutyl-1,3-dimethoxypropane

### Step 1: synthesis of diethyl 2-cyclohexyl-2-isobutylmalonate

This derivative was prepared according to the synthesis described in Example 1-step 2, using isobutyl bromide as alkylating agent. The product was a light yellow oil with a purity of 92%, yield 80%. ¹HNMR (δ, 400 MHZ, CDCl₃): 4.1 (q, 4H, OCH₂), 1.9-1.6 (m, 8H, cyclohexyl+n-butyl), 1.4-0.9 (m, 12H, OCH₂CH₃+cyclohexyl+n-butyl), 0.8 (d, 6H, (CH₃)₂ isobutyl).

### Step 2: synthesis of 2-cyclohexyl-2-isobutyl-1,3-propandiol

This derivative was prepared according to the synthesis described in Example 1-step 3. The product was a colorless viscous oil with a purity of 88%, yield 84%. ¹HNMR (δ, 400 MHZ, CDCl₃): 3.9-3.7 (dd, 4H, OCH₂), 2.3 (s, 2H, OH), 1.8-1.0 (m, 14H, cyclohexyl+isobutyl), 0.9 (d, 6H, (CH₃)₂ isobutyl).

### Step 3: synthesis of 2-cyclohexyl-2-isobutyl-1,3-dimethoxypropane

This derivative was prepared according to the synthesis described in Example 1-step 4. The final product, purified by distillation (115° C./0.5 mmHg), was a colorless oil with a purity of 98%, yield 75%, ¹HNMR (δ, 400 MHz, CDCl₃): 3.3 (s, 6H, CH₃O), 3.3 (s, 4H, OCH₂), 1.8-1.1 (m, 14H, cyclohexyl+isobutyl), 0.9 (d, 6H, (CH₃)₂ isobutyl).

### Synthesis of 2-cyclopentyl-2-isopentyl-1,3-dimethoxypropane

### Step 1: synthesis of diethyl 2-cyclopentylmalonate

This derivative was prepared according to the synthesis described in Example 1-step 1, using cyclopentyl bromide as alkylating agent. The product was a colorless oil with a purity of 99%, yield 56%. ¹HNMR (δ, 400 MHZ, CDCl₃): ¹HNMR (δ, 400 MHZ, CDCl₃): 4.2 (q, 4H, OCH₂), 3.2 (d, 1H, CH malonic), 2.2 (m, 1H, CH cyclopentyl), 1.7-0.8 (m, 14H, OCH₂CH₃+cyclopentyl).

### Step 2: synthesis of diethyl 2-cyclopentyl-2-isopentylmalonate

This derivative was prepared according to the synthesis described in Example 1-step 2, using isobutyl bromide as alkylating agent. The product was a light yellow oil with a purity of 92%, yield 80%. ¹HNMR (δ, 400 MHZ, CDCl₃): 4.1 (q, 4H, OCH₂), 2.4 (m, 3H, CH cyclopentyl+α-CH₂ isopentyl), 1.6-1.3 (m, 8H, cyclopentyl), 1.2-1.0 (m, 9H, OCH₂CH₃· isopentyl), 0.8 (d, 6H, (CH₃)₂ isopentyl).

### Step 3: synthesis of 2-cyclopentyl-2-isopentyl-1,3-propandiol

This derivative was prepared according to the synthesis described in Example 1-step 3. The product was a colorless viscous oil with a purity of 97%, yield 90%. ¹HNMR (δ, 400 MHZ, CDCl₃): 3.8-3.6 (dd, 4H, OCH₂), 2.4 (s, 2H, OH), 1.7-1.0 (m, 14H, cyclopentyl+isopentyl), 0.9 (d, 6H, (CH₃)₂ isopentyl).

### Step 4: synthesis of 2-cyclopentyl-2-isopentyl-1,3-dimethoxypropane

This derivative was prepared according to the synthesis described in Example 1-step 4. The final product was a colorless oil with a purity of 98%, yield 92%. ¹HNMR (δ, 400 MHZ, CDCl₃): 3.3 (s, 6H, CH₃O), 3.3 (s, 4H, OCH₂), 1.8-1.1 (m, 14H, cyclopentyl+isopentyl), 0.9 (d, 6H, (CH₃)₂ isopentyl).

### Preparation of solid catalyst component—general procedure

Into a 1000 mL four-necked round flask, purged with nitrogen, 500 mL of TiCl₄ were introduced at 0° C. While stirring, 20 grams of the microspheroidal MgCl₂.2.1EtOH adduct were added. Then, an amount of electron donor of formula (I) such as to have a Mg/Donor ratio of 6 was charged at 0° C.

The temperature was raised to 100° C. and maintained for 120 minutes. The stirring was stopped. The liquid was siphoned off. The treatment with TiCl₄ was repeated at 120° C. for 60 minutes. After sedimentation and siphoning, the solid was washed with anhydrous i-hexanes (6×100 ml) and dried, thereby obtaining a free flowing powder. The characterization of the resulting solid catalytic component is reported in Table 1.

### General procedure for the homo-polymerization of propylene in bulk

A 4-liter steel autoclave, equipped with a stirrer, pressure gauge, thermometer, catalyst feeding system, monomer feeding lines, and thermostatic jacket, was purged with nitrogen flow at 70° C. for one hour. Then, at 30° C., under propylene flow, the following components were charged in sequence: 75 ml of anhydrous hexane containing 0.76 g of AlEt₃, about 6 mg of solid catalyst component and, when used, the external donor (type and amount reported in the tables). The autoclave was closed. 2NL of hydrogen were added. Under stirring, 1.2 kg of liquid propylene were fed. The temperature was raised to 70° C. in ten minutes. The polymerization was carried out at this temperature for two hours. At the end of the polymerization, the non-reacted propylene was removed. The polymer was recovered and dried in an oven at 80° C.

### Examples 1-5 and comparative examples 6-10. Polymerization of propylene

Catalysts of Examples 1-5 and comparative examples 6-9 were prepared in accordance with the general procedure described above, using donors described in Table 1. The catalyst characterization and the results of the bulk polymerization of propylene are reported in Table 1.

TABLE 1

| | | Catalyst composition | | | Polymerization results | | |
|---|---|---|---|---|---|---|---|
| | | Ti | ID | Mg | Activity | MI “L” | XI |
| Ex | Internal Donor | wt % | wt % | wt % | kg/g | g/10′ | % wt |
| 1 | 2-cyclohexyl-2-isopentyl- | 4.3 | 20.9 | 15.8 | 137 | 2.7 | 98.2 |
| | 1,3-dimethoxypropane | | | | | | |
| 2 | 2-cyclohexyl-2-(3,3,3- | 3.5 | 23.9 | 15.1 | 119 | 2.3 | 98.3 |
| | trifluoro-n-propyl)-1,3- | | | | | | |
| | dimethoxypropane | | | | | | |
| 3 | 2-cyclohexyl-2-(3- | 4.1 | 20.9 | 15.4 | 182 | 3.2 | 98.2 |
| | methylpentyl)-1,3- | | | | | | |
| | dimethoxypropane | | | | | | |
| 4 | 2-cyclohexy1-2-(3- | 4.4 | 22.7 | 15.5 | 120 | 4.5 | 98.0 |
| | ethylpentyl)-1,3- | | | | | | |
| | dimethoxypropane | | | | | | |
| 5 | 2-cyclohexyl-2-(3,5- | 3.9 | 20.4 | 15.4 | 126 | 3.6 | 98.2 |
| | dimethylhexyl)-1,3- | | | | | | |
| | dimethoxypropane | | | | | | |
| C6 | 2-cyclohexyl-2-n-pentyl- | 4.8 | 19.2 | 14.7 | 95 | 7.4 | 96.8 |
| | 1,3-dimethoxypropane | | | | | | |
| C7 | 2-cyclohexyl-2-n-butyl-1,3- | 6.6 | 19.9 | 16.7 | 108 | 3.7 | 96.3 |
| | dimethoxypropane | | | | | | |
| C8 | 2-cyclohexyl-2-isobutyl-1,3- | 4 | 19.3 | 15.8 | 112 | 3.7 | 96.7 |
| | dimethoxypropane | | | | | | |
| C9 | 2-cyclopentyl-2-isopentyl- | 3.1 | 14.5 | 18.2 | 101 | — | 97.2 |
| | 1,3-dimethoxypropane | | | | | | |
| C10 | 2-i-propyl-2-i-penty1-1,3- | 3.6 | 16.8 | 19.4 | 80 | — | 97.7 |
| | dimethoxypropane | | | | | | |

### Examples 11-16

### Catalyst preparation

Into a 1000 mL four-necked round flask, purged with nitrogen, 500 mL of TiCl₄ were introduced at −3° C. While stirring, 20 grams of the microspheroidal MgCl₂·2.1EtOH adduct were added. Then, for some of the preparations indicated in Table 2, an amount of BiCl₃ to provide Mg/BiCl₃ at a molar ratio (or mr) of 60 was charged at −3° C.

The temperature was raised to 100° C. and maintained for 30 minutes. The stirring was stopped. The liquid was siphoned off. Fresh TiCl₄ and 2-cyclohexyl-2-isopentyl-1,3-dimethoxypropane, as internal donor, were added, thereby providing the Mg/ID molar ratio (or mr) reported in Table 2. The temperature was raised at 120° C. under stirring for 30 minutes. After stopping the stirring, the liquid was siphoned off. The treatment with TiCl₄ was repeated at 120° C. for 15 minutes. After sedimentation and siphoning, the solid was washed with anhydrous i-hexanes (6×200 ml) and dried, thereby obtaining a free flowing powder. Details on the catalyst preparation, characterization and the results of the bulk polymerization of propylene are reported in Table 2.

### Comparative Example 17

### Catalyst preparation

The catalyst preparation was carried out as described in example 16 with the difference that 9,9-bis(methoxymethyl) fluorene was used, instead of 2-cyclohexyl-2-isopentyl-1,3-dimethoxypropane, as internal donor. Details on the catalyst preparation, characterization and the results of the bulk polymerization of propylene are reported in Table 2.

TABLE 2

| | Cat. preparation | | Cat. characterization | | | Polymerization | | | | |
|---|---|---|---|---|---|---|---|---|---|---|
| | Mg/D | Mg/Bi | Ti | ID | ID/Ti | ED | Yield | XI | MIL | PBD |
| Ex | Molar | Molar | % wt | % wt | mr | type | kg/g | % wt | g/10□ | g/ml |
| 11 | 5 | 60 | 2.3 | 14.8 | 1.2 | no | 96 | 98.5 | 2.74 | 0.453 |
| | | | | | | C | 80 | 98.9 | 2 | 0.455 |
| 12 | 5 | — | 3.1 | 16.6 | 1 | no | 97 | 98.5 | 2.3 | 0.442 |
| | | | | | | C | 73 | 99.3 | 2 | 0.445 |
| 13 | 9 | 60 | 2.6 | 12.8 | 0.9 | no | 108 | 98 | 3.2 | 0.444 |
| | | | | | | C | 67 | 99 | 1.7 | 0.445 |
| 14 | 11 | — | 4 | 13.1 | 0.6 | no | 121 | 96.6 | 4.4 | 0.447 |
| | | | | | | C | 77 | 98.6 | 2.5 | 0.445 |
| 15 | 13 | 60 | 3.1 | 11 | 0.7 | no | 102 | 96.4 | 5 | 0.457 |
| | | | | | | C | 74 | 98.5 | 2.6 | 0.458 |
| 16 | 15 | 60 | 3.5 | 10.1 | 0.6 | no | 111 | 95.1 | 6.3 | 0.452 |
| | | | | | | C | 76 | 98.3 | 3.1 | 0.459 |
| C17 | 15 | 60 | 5.2 | 5.4 | 0.2 | no | 92.3 | 82.3 | 35.7 | — |
| | | | | | | C | 37.4 | 95.0 | 8.8 | 0.43 |

TEAL/C Donor molar ratio 20

### Example 18

An initial amount of microspheroidal MgCl₂ 2.8C₂H₅OH was prepared according to the method described in Example 2 of U.S. Pat. No. 4,399,054 but operating at 3,000 rpm instead of 10,000. The resulting adduct had an average particle size of 87 μm and was subjected to thermal dealcoholation at increasing temperatures from 30 to 130° C., operating in nitrogen current until the molar alcohol content per mol of Mg was 1.16. Using this support, the catalyst was prepared and tested in accordance with the general procedures previously described. Details on the catalyst preparation, characterization and the results of the bulk polymerization of propylene are reported in Table 3.

### Comparative Example 19

The catalyst preparation was carried out as described in example 18 with the difference that 9,9-bis(methoxymethyl) fluorene was used instead of 2-cyclohexyl-2-isopentyl-1,3-dimethoxypropane as internal donor. Details on the catalyst preparation, characterization and the results of the bulk polymerization of propylene are reported in Table 3.

TABLE 3

| | Cat. | | | | | | | | | | |
|---|---|---|---|---|---|---|---|---|---|---|---|
| | preparation | | Cat. characterization | | | | Polymerization | | | | |
| | Mg/ID | Ti | Mg | ID | ID/Ti | ED | H₂ | Yield | XI | MIL | PBD |
| Ex | Molar | % wt | wt % | % wt | mr | type | NL | kg/g | % wt | g/10□ | g/ml |
| 18 | 5 | 3.9 | 17.9 | 10.4 | 0.50 | C | 1.5 | 19 | 97.2 | 5.3 | 0.292 |
| | | | | | | D | 2 | 20 | 97.5 | 8.0 | 0.283 |
| C19 | 5 | 5.8 | 16.0 | 3.0 | 0.1 | C | 1.5 | 5.6 | 91.9 | 17.2 | 0.354 |
| | | | | | | D | 2 | 9.4 | 87.6 | 24.9 | 0.375 |

TEAL/ED molar ratio = 4

What is claimed is:

1. A solid catalyst component for the polymerization of olefins comprising:
a magnesium halide,
a titanium compound having at least a Ti-halogen bond, and
at least an electron donor of formula (I) 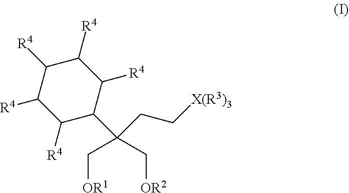
wherein R¹ and R² are, independently, C₁-C₈alkyl groups, X is Si or C, R³ and R⁴ groups, independently, are selected from the group consisting of hydrogen, C₁-C₂₀ hydrocarbon groups and halogens with the proviso that at least two of R³ are not hydrogen.

2. The solid catalyst component according to claim 1, wherein R¹ and R² are the same and selected from C₁-C₄ linear or branched alkyl groups.

3. The solid catalyst component according to claim 1, wherein R⁴ groups, independently, are selected from the group consisting of hydrogen, C₁-C₁₀ hydrocarbon groups and halogens.

4. The solid catalyst component according to claim 3, wherein the R⁴ groups are hydrogen.

5. The solid catalyst component according to claim 1, wherein R³ groups are selected from the group consisting of hydrogen, C₁-C₁₀ hydrocarbon groups, and halogens.

6. The solid catalyst component according to claim 1, wherein R³ group is a hydrocarbon group it is selected from the group consisting of C₁-C₄ linear or branched alkyl groups, and groups linked together, thereby forming a C₆ saturated ring optionally substituted with C₁-C₄ linear alkyl groups.

7. The solid catalyst component according to claim 1, wherein R³ group is a halogen selected from the group consisting of Cl and F.

8. The solid catalyst component according to claim 1, wherein X is carbon.

9. The solid catalyst component according to claim 1, wherein the molar ratio between the electron donor of formula (I) and the Ti atoms in the final solid catalyst component ranges from 0.3:1 to 1.5:1.

10. The solid catalyst component according to claim 1, wherein the molar ratio between the Mg atoms and the electron donor of formula (I) in the final solid catalyst component ranges from 2.5:1 to 50.0:1.

11. The solid catalyst component according to claim 1, further comprising additional donors selected from the group consisting of esters of aliphatic dicarboxylic acids.

12. The solid catalyst component according to claim 1, further comprising additional metal compounds free of metal-carbon bonds and comprising elements selected from the group consisting of Cu, Zn, and Bi.

13. A catalyst for the polymerization of olefins CH₂—CHR, in wherein R is hydrogen or a hydrocarbon radical with 1-12 carbon atoms, comprising:
the product of the reaction between:
(i) the solid catalyst component according to claim 1 and
(ii) an alkylaluminum compound.

14. The catalyst according to claim 13, further comprising an external electron donor compound selected from silicon compounds of formula (R⁷)ₐ(R⁸)_{b}Si(OR⁹)_{c}, where a and b are integers from 0 to 2, c is an integer from 1 to 4 and the sum (a+b+c) is 4; R⁷, R⁸, and R⁹, are alkyl, cycloalkyl or aryl radicals with 1-18 carbon atoms optionally containing heteroatoms.

15. A process for the homopolymerization or copolymerization of olefins CH₂—CHR, wherein R is hydrogen or a hydrocarbon radical with 1-12 carbon atoms, carried out in the presence of a catalyst according to claim 13.
